(19) United States
(12) Patent Application Publication
(10) Pub. No.: US 2009/0146894 A1
(43) Pub. Date: Jun. 11, 2009

(54) RECONFIGURABLE ANTENNA STEERING PATTERNS

(75) Inventors: Jerome P. Drexler, Wyoming, MN (US); Robert C. Becker, Eden Prairie, MN (US); David W. Meyers, Brooklyn Park, MN (US); Kelly P. Muldoon, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/951,018

(22) Filed: Dec. 5, 2007

(51) Int. Cl. H01Q 3/00

(52) U.S. Cl. 343/757

(57) ABSTRACT

A method of configuring a reconfigurable antenna is disclosed. The method selects an antenna configuration pattern based on previously identified antenna configuration patterns where the previously identified antenna configuration patterns have known signal beam pattern characteristics. The method applies reconfigurable antenna steering patterns based on the selected configuration pattern to configure a reconfigurable antenna.

### RELATED APPLICATION

This application is related to commonly assigned U.S. patent application Ser. No. ______ (Attorney Docket No. H0012279-5602), filed on even date herewith and entitled “RECONFIGURABLE ANTENNA PATTERN VERIFICATION” (the '279 Application). The '279 Application is incorporated herein by reference.

### BACKGROUND

Current antenna technology results in fixed-length, or finite and manual-adjustment, antennas that are typically integer multiples of one quarter of a wavelength in length or antennas that include an electrical load. For example, a fixed-length antenna may range in length from inches for a super high frequency antenna to miles for an extremely low frequency antenna. Tactical and mobile communication systems require antennas that have high gain and are small and lightweight. These systems could benefit from antennas with adjustable directional characteristics to avoid receiving signals from jam sources or minimize system detection by sensors in relative proximity of the main beam of the antenna. Fixed-length antennas typically radiate well, but cannot be adjusted or reconfigured easily.

The use of modeling in the design of antennas is known. Typically, antenna designers use classic Euclidean geometry (for example, simple squares, circles, and triangles) to design the shape of an antenna to obtain certain antenna characteristics. For example, the antenna designers will use various patterns and shapes for finer resolution and control of the antenna signal beam shape, also known as the antenna pattern or radiation pattern. This pattern shaping to obtain desired antenna characteristics is typically referred to as antenna beam steering or beam shaping. Geometric antennas usually have well defined, fixed characteristics.

The fixed characteristics of a geometric antenna are less desirable in an environment where multiple frequency, beam-steerable operation is warranted. Presently, multiple antennas are used to achieve the desired frequency coverage, and steerable beam operation largely does not exist. The only existing steerable beam, non-geometric antennas are of a class called phased array antennas. Phased array antennas do not operate over a wide range of frequencies and are very expensive due to the huge number of phase control elements required to create even a rudimentary antenna. In addition, these phased array antenna types generate grating lobes, which are sidelobes that result from radiation from multiple sources at constant fractional wavelength separations.

Reconfigurable antennas represent a class of antenna that normally does not have a specific characteristic. Instead, this class of antennas require configuration before they are usable. Reconfigurable antennas can operate over large frequency ranges and can be beam-steered without the use of multiple radiating elements and phase shifters. In addition, this class of antenna does not generate grating lobes because the radiation source is a continuous element instead of a multiplicity of individual elements. Reconfigurable antennas can accommodate a wide variety of specifications, such as beam width, operating frequency, and radiation angle. Moreover, these antennas are entirely different from a conventional antenna, such as a yagi. The difficulty with an antenna of this type is to determine a configuration that offers the desired performance based on a particular set of requirements.

For the reasons stated above and for other reasons stated below which will become apparent to those skilled in the art upon reading and understanding the present specification, there is a need in the art for improvements in reconfigurable antennas.

### SUMMARY

The following specification discloses at least one method for providing antenna configuration patterns for reconfigurable antenna arrays. This summary is made by way of example and not by way of limitation. It is merely provided to aid the reader in understanding some aspects of at least one embodiment described in the following specification.

Particularly, in one embodiment, a method of configuring a reconfigurable antenna is provided. The method selects an antenna configuration pattern based on previously identified antenna configuration patterns where the previously identified antenna configuration patterns have known antenna patterns and operating frequency characteristics. The method applies reconfigurable antenna steering patterns based on the selected configuration pattern to configure a reconfigurable antenna, characterizes the antenna performance, and modifies the configuration until the desired characteristics are achieved. In addition, information relating to the modified antenna configuration can be stored in static configuration tables until the configuration is recalled.

### DRAWINGS

These and other features, aspects, and advantages are better understood with regard to the following description, appended claims, and accompanying drawings where:

FIG. 1 is a block diagram of an embodiment of a system for antenna design;

FIG. 2 is a block diagram of an embodiment of a reconfigurable antenna;

FIG. 3 is a block diagram of an embodiment of an electronics module of reconfigurable antenna elements;

FIG. 4 is a block diagram of at least one embodiment of a reconfigurable antenna steering pattern provided by a reconfigurable antenna;

FIG. 5 is a flow diagram of a method for configuring a reconfigurable antenna; and

FIG. 6 is a flow diagram of a method for providing reconfigurable antenna steering patterns.

The various described features are drawn to emphasize features relevant to the embodiments disclosed. Like reference characters denote like elements throughout the figures and text of the specification.

### DETAILED DESCRIPTION

Embodiments disclosed herein relate to reconfigurable antenna arrays that form a plurality of antenna steering patterns. In at least one embodiment, an antenna design system provides antenna steering and pattern modules operable to control embedded electronics and configure individual antenna elements to form the antenna steering patterns discussed here. For example, the system directs a programmable controller unit to send commands to an array of switches to configure a particular antenna. Accordingly, at least one signal beam pattern is developed for each unique steerable antenna because of the difference in radio-frequency (RF) propagation characteristics that result from a difference in size and shape (among other factors) of each of the antenna steering configurations.

In one implementation, the antenna design system provides a deterministic process to measure the RF beam forming and frequency characteristics from the antenna for a given configuration pattern that controls a series of antenna array switches. Based on this measurement, a static table is created that lists various antenna characteristics for a given input configuration. The given input configuration is used to reliably configure the antenna for a desired antenna pattern and operating frequency.

For example, the antenna steering module controls embedded electronics in order to configure the individual elements which combine to form each of the reconfigurable antenna patterns. The antenna steering module issues commands to the antenna array switches to form the steerable antenna with a known radiation beam shape at a particular frequency. The antenna steering module selects a configuration of switches in the reconfigurable antenna array that creates antenna patterns that form a signal beam in a desired direction and at the desired frequency.

In one implementation, the antenna configuration is created from a combination of antenna radiation theory and antenna output analysis. For example, through the use of a controlled series of antenna configuration inputs in a laboratory environment, measurements of the RF field of frequency and beam characteristics are recorded. The recorded configurations are used by the antenna steering module to configure the antenna array to the desired signal beam pattern.

In the same or in at least one alternate implementation, an antenna pattern generation module within the system produces all possible valid circuit configurations to be used to configure the antenna beam and frequency for a plurality of steerable antenna configurations. For example, one or more antenna characteristic measurements (typically beam radiation pattern and operating frequency) are recorded with the associated switch array pattern configuration of the reconfigurable antenna array. In one implementation, the antenna pattern generation module stores the antenna characteristic measurements relating to the valid configuration patterns in a database of antenna configuration patterns. For example, information relating to a modified antenna configuration can be stored in static configuration tables in the antenna pattern generation module until the information is recalled.

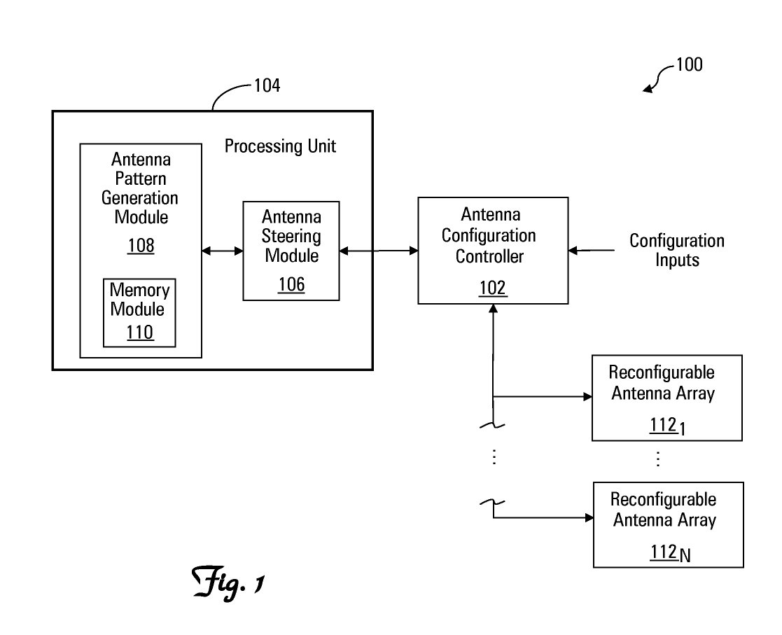

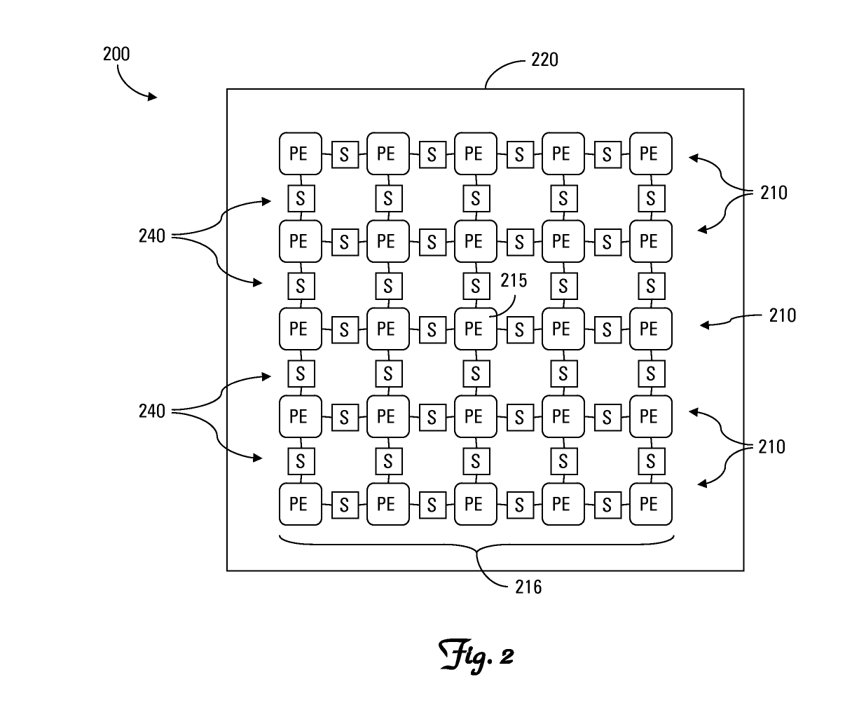

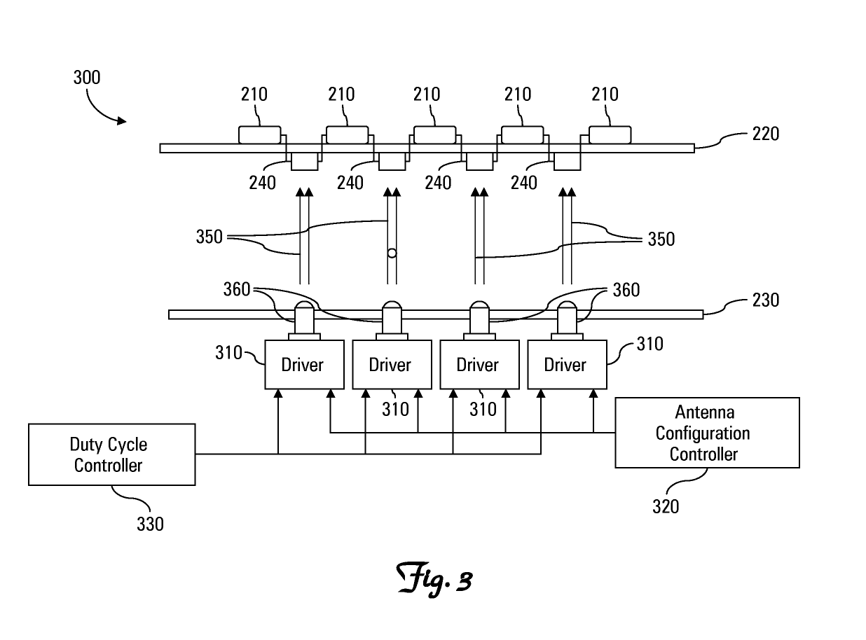

FIG. 1 is a block diagram of an embodiment of an electronic system 100 for antenna design. The system 100 comprises an antenna configuration controller 102, a processing unit 104 in operative communication with the antenna configuration controller 102, and at least one reconfigurable antenna array 112 communicatively coupled to the antenna configuration controller 102. In one implementation, the antenna configuration controller 102 is operable as an antenna configuration module within the processing unit 104. The processing unit 104 further comprises an antenna steering module 106 and an antenna pattern generation module 108. In the example embodiment of FIG. 1, the processing unit 104 further includes a memory unit 110 coupled to the antenna pattern generation module 108. In one implementation, the memory unit 110 is a portion of (that is, resides within) the antenna pattern generation module 108, and the at least one reconfigurable antenna array 112 is in direct communication with the antenna steering module 106. The processing unit 104 is a microprocessor, a microcontroller, a field-programmable gate array (FPGA), a field-programmable object array (FPOA), a programmable logic device (PLD), an application-specific integrated circuit (ASIC), or the like. It is understood that the system 100 is capable of accommodating any appropriate number of reconfigurable antenna arrays 112 (for example, a plurality of reconfigurable antenna arrays 112₁ to 112_{N}) in a single system 100. The composition of at least one of the reconfigurable antenna arrays 112 is discussed in further detail below with respect to FIGS. 2 and 3.

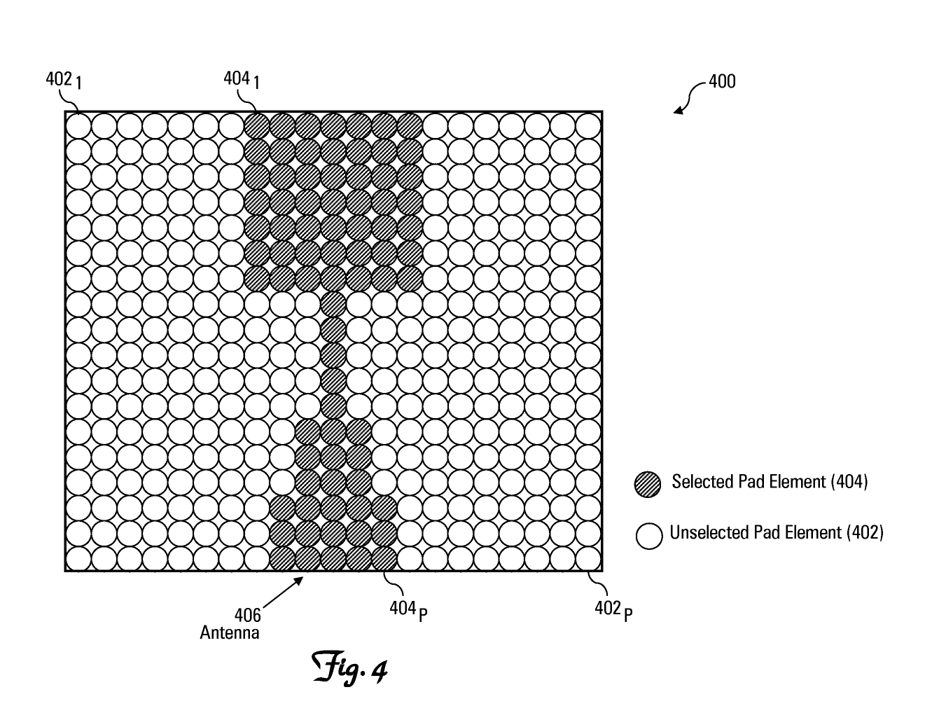

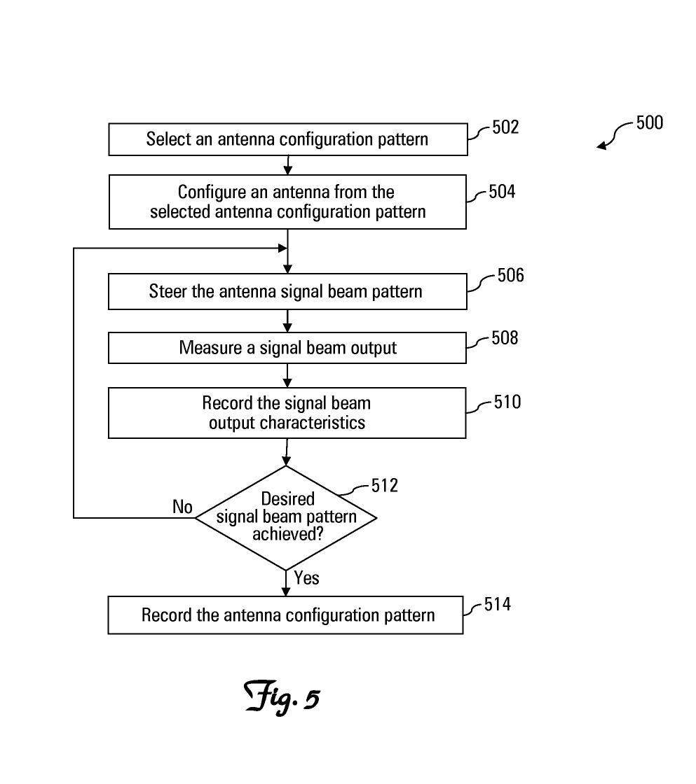

In operation, the system 100 provides a plurality of antenna configurations based on a desired signal beam pattern as further discussed below with respect to FIGS. 4 and 5. In one implementation, the antenna configuration controller 102 receives one or more programmable antenna configuration inputs as shown in FIG. 1. For example, the antenna pattern generation module 108 provides the antenna configurations based on at least one previously-identified radiation pattern of frequency and direction from the one or more programmable antenna configuration inputs. In the same example, the antenna configuration controller 102 constructs at least one antenna with at least one of the reconfigurable antenna arrays 112 based on the desired radiation pattern and direction of an antenna signal beam. In one implementation, the antenna steering module 106 receives configuration commands from the antenna configuration controller 102 to construct the antenna. Alternatively, the antenna steering module 106 selects the antenna pattern from the antenna pattern generation module 108. The antenna steering module 106 selects at least one configuration for at least one of the reconfigurable antenna arrays 112 that will steer each of the antenna patterns to resonate and form a signal beam of a desired direction and frequency, as further described below with respect to FIGS. 2 and 3.

The processing unit 104 reproduces the plurality of antenna configurations to steer the at least one antenna pattern to provide the desired signal pattern in a desired direction and frequency. In one implementation, the antenna pattern generation module 108 records a plurality of antenna configuration measurements, the configuration measurements comprising known signal pattern beam characteristics. In one implementation, the memory module 110 is operable to store the plurality of antenna configurations with the associated switching pattern for at least one of the reconfigurable antenna arrays 112.

The antenna pattern generation module 108 comprises a database of antenna configuration patterns with various radiation characteristics (for example, a series of antenna patterns with desired performance characteristics). The antenna pattern generation module 108 allows for later retrieval of antenna configurations based on prior-generated data sets (for example, an “encyclopedia” or “dictionary” of antenna steering patterns). The antenna pattern generation module 108 can provide an indication of the antenna array elements not to use and the antenna array elements that affect antenna steering. The antenna steering module 106 allows for estimating which configuration patterns are productive based on one or more previously identified performance characteristics (for example, the desired frequency and direction of an antenna signal beam provided by the antenna array elements). In one implementation, the antenna steering module 106 further comprises a segment weighting analysis operable to analyze any usefulness of connecting a particular segment (for example, activating at least two antenna array elements to form the segment). Moreover, each analyzed configuration pattern is stored in the memory module 110 of the antenna pattern generation module 108. The antenna pattern generation module 108 allows for rapid lookup of one or more configurations to regenerate (for example, an antenna with the one or more performance characteristics). Alternatively, use of the antenna pattern generation module 108 reduces the number of tries required to obtain the desired antenna performance.

FIG. 2 is an example embodiment of a reconfigurable antenna (aperture) 200 operable to provide the steerable antenna configuration patterns discussed herein. In the example embodiment of FIG. 2, the reconfigurable antenna 200 represents the reconfigurable antenna array 112 of FIG. 1. The reconfigurable antenna 200 comprises a matrix of metallic pad elements (PE) 210 arranged in an array 216. In one embodiment, pad elements 210 are mounted onto a printed circuit board 220. The printed circuit board 220 is suspended over a ground plane 230 to form an antenna, as illustrated in FIG. 3. The aperture 200 further comprises a plurality of switches (S) 240 which function to couple or decouple neighboring pad elements 210 together.

In operation, one of the pad elements 210 (for example, a center element 215) is driven by an electrical signal. By opening and closing one or more of the switches 240, the pattern in which current flows from the center element 215 through the pad elements 210 of the reconfigurable antenna 200 is configured. In one implementation, the pattern of current flow is configured to create the steerable antenna configuration patterns, such as but not limited to a bent wire pattern and a spiral pattern, each with known signal beam patterns. As illustrated in FIG. 3, the switches 240 are optically driven switches. In the example embodiment of FIG. 3, the optically driven switches 240 avoid the need for additional control wires located near the pad elements 210, which would tend to distort the radiation pattern of the aperture 200.

FIG. 3 is a block diagram of an embodiment of an electronics module 300 comprising the pad elements 210 of FIG. 2. The module 300 further comprises a plurality of light sources 360 each controlled by an associated driver 310. In one embodiment, the plurality of light sources 360 comprises vertical-cavity surface-emitting lasers (VCSELs), and the like. In one embodiment, the light sources 360 are embedded into the ground plane 230 and positioned to illuminate exactly one of the switches 240. In one embodiment, each driver 310 controls one or more of light sources 360. An antenna configuration controller 320 is coupled to communicate the desired antenna configuration pattern to the drivers 310. In one embodiment, the antenna configuration controller 320 represents the antenna configuration controller 102 of FIG. 1. Based on the communicated antenna configuration pattern, each driver 310 will turn off one or more of switches 240 by turning on one or more of light sources 360. In one embodiment, a duty cycle controller 330 is also coupled to the drivers 310 to communicate a duty cycle signal to each of the drivers 310 for cycling light sources 360. For example, in one embodiment, the duty cycle controller 330 is coupled to an output enable pin of each driver 310.

In operation, for each switch 240 which should be in an ON state based on the antenna array pattern communicated from the antenna configuration controller 320, the drivers 310 will cycle the associated light sources 360 on (for time t₁) and off (for time t₀) as directed by the duty cycle controller 330. This is done in order to reduce the power consumption of the switch drivers without impacting switch performance. In one embodiment, the duty cycle controller 330 outputs a duty cycle signal comprising a square wave signal with a signal low for time t₁ and a signal high for time t₀. By duty cycling the light signals 350 from light sources 360 based on t₁ and t₀, a source voltage value (Vₛ) within each of the switches 240 that need to remain on in order to establish the desired antenna array pattern will be maintained above a minimum voltage level (Vₘᵢₙ) required for switch activation.

FIG. 4 is a block diagram of an example embodiment of a reconfigurable antenna steering pattern provided by a reconfigurable antenna (for example, the reconfigurable antenna array 112 of FIG. 1). This example configuration is shown by way of example and not by way of limitation. A component layer 400 comprises unselected pad elements 402_{I} to 402_{P} and selected pad elements 404_{I} to 404_{P}. The selected pad elements 404_{I} to 404_{P} are arranged as an antenna 406. For example, FIG. 4 illustrates a single antenna configuration for the reconfigurable antenna 200, where the switches 240 adjacent to the selected pad elements 404_{I} to 404_{P} are in an ON state, and the switches 240 adjacent to the unselected pad elements 402_{I} to 402_{P} are in an OFF state. The shape of the antenna 406 substantially resembles a traditional patch antenna with varying radiation characteristics (for example, the input impedance of the antenna). A desired antenna steering pattern for the antenna 406 is finely tuned based on the antenna configuration patterns provided by the antenna steering module 106 to the antenna configuration controller 102.

FIG. 5 is a flow diagram of a method 500 for configuring a reconfigurable antenna. The method 500 addresses selecting an antenna configuration pattern based on previously identified antenna configuration patterns having known signal beam characteristics. The method 500 further addresses applying reconfigurable antenna steering patterns based on the selected configuration pattern to configure the reconfigurable antenna. In one embodiment, the method 500 applies the reconfigurable antenna steering patterns to control programmable antenna array elements of the reconfigurable antenna and provide a desired signal beam pattern from the reconfigurable antenna.

In one implementation, the method of FIG. 5 identifies the antenna configuration pattern based on the desired frequency and direction of the signal beam pattern of the reconfigurable antenna (block 502). The method 500 further selects the antenna configuration pattern by evaluating each of the previously identified antenna configuration patterns having a known radio-frequency (RF) radiation signal beam pattern based on at least one of a size and a shape of an antenna configuration that substantially resembles the selected antenna configuration pattern (block 504). Moreover, the antenna array elements are configured to form the antenna by enabling a first portion of the programmable antenna array elements and disabling a second portion of the programmable antenna array elements. In one implementation, the method 500 uses a segment weighting analysis to determine the first portion of the programmable antenna array elements to enable and the second portion of the programmable antenna array elements to disable.

The method 500 applies the reconfigurable antenna steering patterns by steering the antenna signal beam produced by the programmable antenna array elements based on the reconfigurable antenna steering patterns (block 506). In one implementation, in order to steer the antenna signal beam, the method 500 measures a signal beam output of the antenna (block 508) and records frequency and signal strength characteristics of the signal beam (block 510). Moreover, to adjust the signal beam output of the antenna, the method 500 modifies the antenna configuration pattern (for example, enabling or disabling the antenna array elements) to provide a desired signal beam pattern (block 512). In one embodiment, the configuration is recorded once the desired signal beam pattern is achieved (block 514).

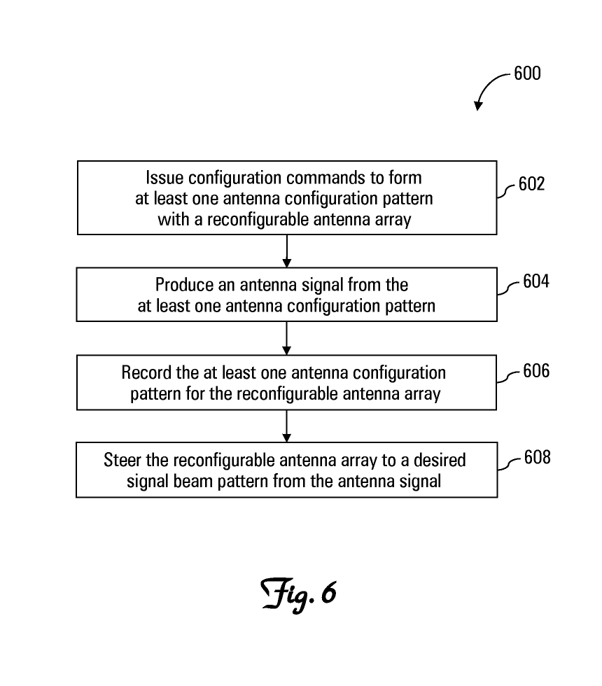

FIG. 6 is a flow diagram of a method 600 for providing reconfigurable antenna steering patterns. The method 600 issues configuration commands to form at least one antenna configuration pattern (block 602) and produces an antenna signal from the at least one antenna configuration pattern with at least one set of signal beam pattern characteristics based on one or more previously identified antenna configuration patterns (block 604). In one implementation, issuing configuration commands to form at least one antenna configuration pattern further comprises measuring a plurality of signal beam patterns for a plurality of antenna steering patterns. The method 600 records the at least one antenna configuration pattern as a reconfigurable antenna steering pattern for a reconfigurable antenna array (block 606), where the at least one antenna configuration pattern is operable to steer programmable elements of the reconfigurable antenna array and form a desired signal beam pattern from the antenna signal (block 608).

In one implementation, the method 600 provides the at least one antenna configuration pattern as a model of a predetermined signal beam strength at a desired frequency. Moreover, the method 600 produces the antenna signal from the at least one antenna configuration pattern and evaluates the at least one antenna configuration pattern based on the one or more previously identified performance characteristics of an antenna signal beam provided by the antenna array elements. In one implementation, the method 600 compiles a database of reconfigurable antenna steering patterns with the antenna signal beam characteristics that substantially provide the desired signal beam pattern. Moreover, the database stores the at least one antenna configuration pattern and an associated switching pattern for the reconfigurable antenna array.

The methods and techniques described here may be implemented in digital electronic circuitry, or with firmware or software in a programmable processor (for example, a special-purpose processor or a general-purpose processor such as a computer), or in combinations of them. An apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory (RAM) or a random access memory (ROM).

Storage devices suitable for tangibly embodying computer program instructions and data include all forms of non-volatile memory, including by way of example semiconductor memory devices, such as (electrically) erasable programmable read-only memory (EPROM or EEPROM), and flash memory devices; magnetic disks such as internal hard disks and removable disks; and magneto-optical disks, including but not limited to digital video disks (DVDs). Any of the foregoing may be supplemented by, or incorporated in, specially-designed application-specific integrated circuits (ASICs), and the like.

This description has been presented for purposes of illustration, and is not intended to be exhaustive or limited to the embodiments disclosed. Variations and modifications may occur, which fall within the scope of the following claims.

What is claimed is:

1. A method of configuring a reconfigurable antenna, the method comprising:
selecting an antenna configuration pattern based on previously identified antenna configuration patterns, the antenna configuration patterns having known signal beam pattern characteristics; and
applying reconfigurable antenna steering patterns based on the selected configuration pattern to configure a reconfigurable antenna.

2. The method of claim 1, wherein selecting the antenna configuration pattern comprises identifying the antenna configuration pattern based on a desired frequency and direction of the signal beam pattern of the reconfigurable antenna.

3. The method of claim 2, wherein identifying the antenna configuration pattern further comprises evaluating the previously identified antenna configuration patterns having a known radio-frequency (RF) radiation signal beam pattern based on at least one of a size and a shape of an antenna configuration that substantially resembles the selected antenna configuration pattern.

4. The method of claim 1, wherein applying the reconfigurable antenna steering patterns comprises configuring programmable antenna array elements of the reconfigurable antenna by enabling a first portion of the programmable antenna array elements and disabling a second portion of the programmable antenna array elements.

5. The method of claim 4, wherein configuring the programmable antenna array elements further comprises modifying the antenna configuration pattern using a segment weighting analysis to determine the first portion of the programmable antenna array elements to enable and the second portion of the programmable antenna array elements to disable.

6. The method of claim 1, wherein applying the reconfigurable antenna steering patterns further comprises:
measuring a signal beam output of the reconfigurable antenna;
recording frequency and signal strength characteristics of the signal beam; and
steering the antenna signal beam produced by the programmable antenna array elements based on the recorded characteristics until a desired signal beam pattern is achieved.

7. A method for providing reconfigurable antenna steering patterns, the method comprising:
issuing configuration commands to form at least one antenna configuration pattern;
producing an antenna signal from the at least one antenna configuration pattern with at least one set of signal beam pattern characteristics based on one or more previously identified antenna configuration patterns; and
recording the at least one antenna configuration pattern as a reconfigurable antenna steering pattern for a reconfigurable antenna array, the at least one antenna configuration pattern operable to control programmable elements of the reconfigurable antenna array and form a desired signal beam pattern from the antenna signal.

8. The method of claim 7, wherein issuing configuration commands to form at least one antenna configuration pattern further comprises measuring a plurality of signal beam patterns for a plurality of reconfigurable antenna steering patterns.

9. The method of claim 7, wherein producing the antenna signal from the at least one antenna configuration pattern further comprises steering the at least one antenna configuration pattern to a desired antenna configuration operable to provide a model of a predetermined signal beam strength at a desired frequency.

10. The method of claim 9, wherein steering the at least one antenna configuration pattern to the desired antenna configuration further comprises:
evaluating the at least one antenna configuration pattern based on the one or more previously identified antenna configuration patterns of an antenna signal beam provided by the antenna array elements; and
compiling a database of reconfigurable antenna steering patterns with the antenna signal beam characteristics that substantially provide the desired signal beam pattern.

11. The method of claim 7, wherein recording the at least one antenna configuration pattern for the reconfigurable antenna array comprises storing the at least one antenna configuration pattern and an associated switching pattern for the reconfigurable antenna array.

12. An electronic system for antenna design, comprising:
an antenna configuration controller operable to receive one or more programmable antenna configuration inputs; and
a processing unit in operative communication with the antenna configuration controller, the processing unit including,
an antenna pattern generation module operable to provide a plurality of antenna configurations based on a desired signal beam pattern requested by the one or more programmable antenna configuration inputs, and
an antenna steering module in communication with the antenna pattern module, the antenna steering module operable to provide at least one antenna pattern for at least one reconfigurable antenna array, wherein the processing unit is operable to reproduce the plurality of antenna configurations and steer the at least one antenna pattern to the desired signal beam pattern.

13. The system of claim 12, wherein the antenna configuration controller is operable as an antenna configuration module within the processing unit.

14. The system of claim 12, wherein the antenna configuration controller is operable to control a plurality of reconfigurable antenna array elements of the at least one reconfigurable antenna array.

15. The system of claim 12, wherein the antenna configuration controller is operable to receive configuration commands from the antenna steering module to construct the plurality of antenna configurations.

16. The system of claim 12, wherein the processing unit reproduces the plurality of antenna configurations based on at least one previously-identified configuration operable to provide a desired signal beam frequency and direction from the one or more programmable antenna configuration inputs.

17. The system of claim 12, wherein the processing unit comprises at least one of a microprocessor, a microcontroller, a field-programmable gate array, a field-programmable object array, a programmable logic device, or an application-specific integrated circuit.

18. The system of claim 12, wherein the antenna pattern generation module further includes a memory module, the memory module operable to store the plurality of antenna configurations with the associated switching pattern for the at least one reconfigurable antenna array.

19. The system of claim 12, wherein the antenna pattern generation module is operable to record a plurality of antenna configuration measurements comprising known signal beam pattern characteristics.

20. The system of claim 12, wherein the antenna steering module is operable to select at least one of the antenna configurations from the antenna pattern module that steers the at least one antenna pattern to form the desired signal beam pattern in a desired direction and frequency.
